(19) United States
(12) Patent Application Publication
(10) Pub. No.: US 2025/0373494 A1
(43) Pub. Date: Dec. 4, 2025

(54) TARGET RELIABILITY LEVEL SELECTION FOR DYNAMIC RELIABILITY CONFIGURATION IN NETWORK SLICE

(71) Applicant: HUAWEI TECHNOLOGIES CO., LTD., Shenzhen (CN)

(72) Inventors: Wint Yi Poe, Munich (DE); Riccardo Trivisonno, Munich (DE); Davide Borsatti, Bologna (IT); Gianluca Davoli, Bologna (IT); Chiara Lombardo, Bologna (IT); Daniela Selvi, Bologna (IT); Roberto Bruschi, Bologna (IT); Walter Cerroni, Bologna (IT); Franco Davoli, Bologna (IT); Carla Raffaelli, Bologna (IT); Raffaele Bolla, Bologna (IT)

(73) Assignee: HUAWEI TECHNOLOGIES CO., LTD., Shenzhen (CN)

(21) Appl. No.: 19/258,652

(22) Filed: Jul. 2, 2025

Related U.S. Application Data
(63) Continuation of application No. PCT/EP2023/050052, filed on Jan. 3, 2023.

(51) Int. Cl. H04L 41/0894; H04L 41/082; H04W 4/50; H04W 48/18

(52) U.S. Cl. CPC H04L 41/0894; H04L 41/082; H04W 4/50; H04W 48/18

(57) ABSTRACT

A control entity is provided for configuring a reliability level of a communication service in a network slice of a communication network, which supports a dynamic reliability of the communication service in the network slice relating to Human-Robot-Interaction (HRI) and/or Human-Robot-Collaboration (HRC) scenarios, which require the dynamic reliability. The control entity is configured to determine one or more operational conditions of one or more user entities, and to determine a target reliability level of the communication service in the network slice of the one or more user entities based on the determined one or more operational conditions. An application function is provided to configure the control entity the dreliability related information of one or more user entities, and a network entity is provided for enforcing the dynamic reliability level for the communication service in the network slice.

### CROSS-REFERENCE TO RELATED APPLICATIONS

This application is a continuation of International Application No. PCT/EP2023/050052, filed on Jan. 3, 2023, the disclosure of which is hereby incorporated by reference in its entirety.

### TECHNICAL FIELD

This disclosure is related to network slicing, especially to 5^{th} generation (5G)-advanced or 6^{th} generation (6G) network slices. The disclosure is concerned with supporting a dynamic reliability of a communication service in a network slice. For instance, the disclosure is relevant for Human-Robot-Interaction (HRI) and/or Human-Robot-Collaboration (HRC) scenarios, which require such a dynamic reliability of communication between user entities. The disclosure presents a control entity, an application entity, and a network entity, respectively, for configuring dynamically the reliability level of a communication service in a network slice, and presents corresponding methods.

### BACKGROUND

HRI or HRC has been growing rapidly in the areas of manufacturing, healthcare, agriculture, logistics, etc. In a HRI or HRC scenario, robotic devices (also referred to as “robots”) and humans (which means, in this disclosure, “human” with user devices, for example, mobile devices like smartphones, tablets, wearable devices or personal computers) are co-located at the same workspace, e.g., on a factory floor. The robotic devices and the humans may, or may not, interact or interwork with each other, depending on the operations of their tasks or applications requirement. It may be assumed that the robotic devices and the humans can both communicate to the network by some means of communication. For example, a human in the factory floor may be attached with a mobile device to the network, and/or a robotic device may be built with a communication channel to the network. Therefore, the network may be fully aware of the past and current locations of the robotic devices and the humans.

When the humans and the robotic devices share the workspace or share performing a task, it may be necessary to provide a (ultra) reliable and low latency supporting communication system. The necessary accuracy of sensing and actions to successfully perform the tasks, imposes certain communication system reliability requirements.

5G and 5G-advanced communication systems already provide some features, which allow the support of high reliability use cases, namely network slicing and ultra-reliable low latency communications (URLLC) technologies. In particular, redundant transmission is considered to support the desired high reliability. However, in the solution of 5G-advanced, reliability is considered as a “static” attribute of network slicing. This means that the reliability level, which characterizes a particular network slice (e.g., URLLC), cannot be adapted once the network slice has been deployed and used by a user entity (also referred to as user equipment (UE)), e.g., a robotic device. In HRI or HRC use cases, the high reliability does not have to be provisioned at all times, but may be provisioned dependently on the operational conditions at the workspace, e.g., the factory floor. Hence, the “static” reliability leverages on resource overprovisioning, and leads to inefficient resource and energy consumption of the network.

In 3GPP TS22.261, the reliability is defined as “in the context of network layer packet transmissions, percentage value of the packets successfully delivered to a given system entity within the time constraint required by the targeted service out of all the packets transmitted”. Basically, the reliability is considered as an upper bound reliability to be supported by the network. However, no dynamic reliability concept has been defined.

In the above solutions, the network basically provides two disjoint paths at the user plane or transport layer, in order to achieve a high reliability requirement. However, none of the described solutions envisions an adaptive reliability requirement. On the one hand, the redundant transmissions may support the high reliability requirement, but on the other hand, the resources required for the redundant transmissions are inefficient, because many services or applications do not require a high reliability at all times. This may lead to unnecessary overprovisioning of network resources, and thus costs related to access, control plane, and user plane.

### SUMMARY

This disclosure aim to improve the above-described solutions. An objective is to address the fact that a high reliability may not be required at all times. Another objective is to avoid overprovisioning of network resources. Another objective is to achieve at least the same performance as the described solutions using redundant transmissions, however, with a more efficient resource usage and energy consumption. Another objective is to determine a “dynamic” reliability level requirement for a network slice, so that the proper reliability level can be provisioned at varying times for the network slice, without overprovisioning resources.

These and other objectives are achieved by this disclosure as described in the independent claims. Advantageous implementations are further described in the dependent claims.

The term “reliability” or “reliability level” or “reliability requirement” in this disclosure has the same concept as the reliability defined in URLLC slice defined in 3GPP TS 22.261 and 23.501.

A first aspect of this disclosure provides a control entity for configuring a reliability level of a communication service in a network slice of a communication network, the control entity being configured to: determine one or more operational conditions of one or more user entities; and determine a target reliability level of the communication service in the network slice of the one or more user entities based on the determined one or more operational conditions. The meaning of ‘determine one or more operational conditions of one or more user entities’ may be in advance detection of the one or more operational conditions of the one or more user entities.

By selecting the target reliability level in dependence of the operational condition of the user entities in varying time, enables a dynamic configuration of the reliability level of the communication service in the network slice. Thereby, the target reliability level may be selected from a plurality of possible reliability levels. The control entity is able to determine the proper reliability level of communication for the user entities using the network slice at all times. As this allows a situation, where a highest possible reliability level is not necessarily provided at all times, overprovisioning of network resources can be avoided.

The operational conditions may be related to a robotic device at a factory floor, for example, by considering various parameters, so that the impact to the reliability level of a certain communication service (e.g., a URLLC network slice) can be determined. The control entity may receive the one or more operational conditions by indication from the one or more user entities themselves, or from another network entity or from another 3^{rd} party devices. Alternatively, the control entity may measure or determine or collect the one or more operational conditions itself, or may estimate the one or more operational conditions.

The one or more user entities may be included in a group of user entities, for instance, may form a group of user entities. The target reliability level may be specific to a user entity or to the group of user entities. The one or more user entities may comprise robotic devices and/or may comprise humans (i.e., human attached with user devices, e.g., mobile devices), and may generally be referred to as UEs.

In an implementation form of the first aspect, the control entity is further configured to: enforce the target reliability level of the communication service in the network slice of the one or more user entities; or provide the target reliability level to a network entity for the enforcement of the target reliability level of the communication service in the network slice of the one or more user entities.

Enforcing the target reliability level of the communication service in the network slice may mean configuring the communication service in the network slice such that the target reliability level can be achieved for a communication between the user entities. For example, the control entity configures a multi-path communication service in the network slice which can be achieved the target reliability level. In this example, the configuration of the multi-path communication service in the network slice means how many paths are needed and which available paths in the network are selected to achieve the target reliability level. Then the necessary actions of such a configuration can be done together with the other network entities. Another example is that the control entity may be adapted to configure the reliability level in the network slice by setting or adapting relevant parameters of the network slice, wherein the parameters are determinative of the communication service reliability.

In case that the control entity provides the target reliability level to the network entity for the enforcement, this means that the reliability level of the communication service in the network slice is not actively enforced by the control entity, but is actively enforced by said network entity. The control entity only provides the information of which reliability level to enforce, and potentially how, i.e., may indicate some communication service reliability relevant parameters to the network entity.

In an implementation form of the first aspect, the control entity is further configured to: store dynamic reliability policy information related to the one or more user entities using the network slice, wherein the reliability policy information comprises a correlation between a plurality of operational conditions for the user entity or the group of user entities and a plurality of reliability levels; and determine the target reliability level of the communication service in the network slice of the one or more user entities based on the determined one or more operational conditions and according to the dynamic reliability policy information.

The control entity may maintain the dynamic reliability policy information, for example, it can refresh or update the stored information. The control entity may also generate the information in the first place, or may be configured from external entity with the dynamic reliability policy information. Thus, the reliability policy information can be dynamic.

In an implementation form of the first aspect, the control entity is further configured to select the target reliability level from a plurality of reliability levels having different percentage value of packet delivery success rate to a given system entity.

The highest possible packet delivery success rate may not be required at all times, and in this case, a lower packet delivery success rate may be selected.

In an implementation form of the first aspect, the control entity is further configured to: expose the stored dynamic reliability policy information related to the one or more user entities so that it is configurable by an application entity; and/or generate and/or update the dynamic reliability policy information based on a reliability configuration received from an application entity or from a network entity.

Exposing may mean in this case, that the control entity makes the dynamic reliability policy information visible or discoverable to/for the application entity, and provides the application entity with the rights to configure and amend the dynamic reliability policy information, although it is stored at the control entity. The reliability configuration may work as an instruction from the application entity to the control entity, in order to configure and amend the dynamic reliability policy information by the control entity.

In an implementation form of the first aspect, the control entity is configured to: determine the one or more operational conditions of the one or more user entities by estimating, at a first time point, the one or more operational conditions related to the one or more user entities for a second time point, wherein the second time point is later than the first time point; and determine the target reliability level for the first time point and second time point based on the one or more estimated operational conditions of the one or more user entities.

In an implementation form of the first aspect, the control entity is configured to: determine the one or more operational conditions by estimating the one or more operational conditions based on previously determined one or more operational conditions of the one or more user entities.

In an implementation form of the first aspect, the control entity is configured to: determine the one or more operational conditions of the one or more user entities using an intelligence methodology with a trained model.

For instance, the trained model may comprise a neural network model, for example, a convolutional neural network (CNN) model. The model may have been trained using a training set comprising operational conditions and combinations of operational conditions correlated with certain network parameters, which the control entity is able to measure or determine. The intelligence methodology may comprise using the trained model to determine the one or more operational conditions. For instance, by providing, as input to the trained model, certain network parameters, which the control entity is able to measure or determined in an inference phase. The intelligence methodology may comprises deep learning and/or machine learning.

In an implementation form of the first aspect, the control entity is configured to: continuously monitor or determine the one or more operational conditions of the one or more user entities.

For instance, the control entity may receive signaling, e.g. repeatedly or periodically in certain intervals, from the user entities or from another network entity, wherein the signaling is indicative of the one or more operational conditions. The control entity may also continuously measure certain network parameters and may therefrom infer the operational conditions in certain intervals or constantly.

In an implementation form of the first aspect, the one or more operational conditions of the one or more user entities comprise at least one of: a distance between a user entity and two or more other user entities; a density of multiple user entities; a movement speed of a user entity and one or more other user entities; a movement direction of a user entity and one or more other user entities; a movement trajectory of a user entity and one or more other user entities; a type of a task or operations performed by a user entity and one or more user entities.

In an implementation form of the first aspect, the user entities comprise a first group of one or more user entities and a second group of one or more user entities; and the one or more operational conditions of the user entities comprise one or more distances between a respective user entity of the first group and a respective user entity of the first group or second group.

For instance, the first group may comprise robotic devices and the second group may comprise humans (i.e., human with user devices, e.g., mobile devices).

In an implementation form of the first aspect, the control entity is configured to: determine a higher target reliability level, if a minimum distance of the one or more distances is below a threshold value; and determine a lower target reliability level, if the minimum distance of the one or more distances is equal to or above the threshold value.

A higher reliability level may have a higher packet delivery success rate than a lower target reliability level, or the same for similar parameters.

In an implementation form of the first aspect, the user entities comprise a first group of one or more user entities and a second group of one or more user entities; and the one or more operational conditions comprise a number of collaborative tasks performed by at least one user entity of the first group and at least one user entity of the second group.

For instance, the first group may comprise robotic devices and the second group may comprise humans.

In an implementation form of the first aspect, the control entity comprises a network data analytics function (NWDAF), or a network intelligent function, which is configured to determine the one or more operational conditions of the one or more user entities and to determine the target reliability level of the one or more user entities.

In an implementation form of the first aspect, the control entity further comprises a policy control function (PCF) which is configured to maintain and/or generate and/or update the dynamic reliability policy information.

A second aspect of this disclosure provides an application entity for configuring a dynamic reliability policy information of a communication service in a network slice of a communication network, the application entity being configured to: provide a reliability related configuration to a control entity; wherein the reliability related configuration is adapted to instruct the control entity to generate or update dynamic reliability policy information related to one or more user entities using the network slice; and wherein the dynamic reliability policy information comprises a correlation between a plurality of operational conditions for the one or more user entities using the network slice and a plurality of reliability levels.

By providing the reliability related configuration to the control entity, the control entity is supported to configure the dynamic reliability level of the communication service in the network slice in dependence of the operational conditions of the user entities using the network slice. Thus, the advantages described above for the control entity are achieved.

A third aspect of this disclosure provides a network entity for configuring a reliability level of a communication service in a network slice of a communication network, the network entity being configured to: receive a first target reliability level of the communication service in the network slice of one or more user entities, from a control entity; enforce the first target reliability level of the communication service in the network slice of the one or more user entities at a first time point, or provide the first target reliability level to another network entity for the enforcement at the first time point; receive a second target reliability level of the communication service in the network slice of one or more user entities, from the control entity; and enforce the second target reliability level of the communication service in the network slice of one or more user entities at a second time point, or provide the second target reliability level to another network entity for the enforcement at the second time point.

Based on the dynamic reliability level of the communication service in the network slice, which is received from the control entity, the network entity is able to enforce the respective reliability of the communication service for one or more user entities using the network slice. Thus, the advantages described above for the control entity are achieved.

A fourth aspect of this disclosure provides a method for configuring a reliability level of a communication service in a network slice of a communication network, wherein the method is performed at a control entity and comprises: determining one or more operational conditions of one or more user entities; and determining a target reliability level of the communication service in the network slice of the one or more user entities based on the determined one or more operational conditions.

The method of the fourth aspect may have implementation forms that correspond to the implementation forms of the control entity of the first aspect. The method of the fourth aspect and its implementation forms may achieve the same advantages as described above for the control entity of the first aspect and its respective implementation forms.

A fifth aspect of this disclosure provides a method for configuring a dynamic reliability policy information of a communication service in a network slice of a communication network, wherein the method is performed at an application entity and comprises: providing a reliability related configuration to a control entity; wherein the reliability related configuration is used to instruct the control entity to generate or update dynamic reliability policy information related to one or more user entities using the network slice; and wherein the dynamic reliability policy information comprises a correlation between a plurality of operational conditions for of the one or more user entities using the network slice and a plurality of reliability levels for.

The method of the fifth aspect may have implementation forms that correspond to the implementation forms of the application entity of the second aspect. The method of the fifth aspect and its implementation forms may achieve the same advantages as described above for the application entity of the second aspect and its respective implementation forms.

A sixth aspect of this disclosure provides a method for configuring a reliability level of a communication service in a network slice of a communication network, wherein the method is performed at a network entity and comprises: receiving a first target reliability level of the communication service in the network slice of one or more user entities, from a control entity; enforcing the first target reliability level of the communication service in the network slice of the one or more user entities at a first time point, or providing the first target reliability level to another network entity for the enforcement at the first time point; receiving a second target reliability level of the communication service in the network slice of one or more user entities, from the control entity; and enforcing the second target reliability level of the communication service in the network slice of one or more user entities at a second time point, or providing the second target reliability level to another network entity for the enforcement at the second time point.

The method of the sixth aspect may have implementation forms that correspond to the implementation forms of the network entity of the third aspect. The method of the sixth aspect and its implementation forms may achieve the same advantages as described above for the network entity of the third aspect and its respective implementation forms.

A seventh aspect of this disclosure provides a computer program comprising instructions which, when the program is executed by a computer, cause the computer to perform the method according to one of the fourth aspect, fifth aspect, or sixth aspect, or any implementation form thereof.

An eighth aspect of this disclosure provides a non-transitory storage medium storing executable program code which, when executed by a processor, causes the method according to the fourth aspect, fifth aspect, or sixth aspect, or any of their implementation forms to be performed.

In summary of the above aspects and implementation forms, this disclosure addresses the issue that in 5G telecommunication the reliability is considered as a ‘static’ attribute of network slicing, for example, the URLLC slice type. This means that a URLLC slice is configured and instantiated according to one dedicated ‘static’ value of the reliability level. Based on this ‘static’ configuration, each URLLC application or use case will be mapped to a corresponding URLLC slice that has the highest possible reliability according to the application requirement, hence, leveraging on resource overprovisioning, which leads to inefficiency. In fact, however, not all URLLC applications, for example, HRI applications, require a high reliability to be provisioned at all times, but rather in dependence of the operational conditions of user devices in the network slice. Thus, the dynamic reliability method is introduced and can be configured and enforced by, respectively, the control entity, application entity, and network entity of this disclosure.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows a control entity, an application entity, and a network entity, according to examples of this disclosure.

FIG. 2 shows an architecture of dynamic reliability controller (DRC) being a control entity according to example of this disclosure.

FIG. 3 illustrates an example of user entities including robotic devices and humans at a factory floor, wherein the user entities do not share tasks, but wherein the user entities share the workspace in a HRI/HRC use case.

FIG. 4 shows procedures of the dynamic reliability controller (DRC) of FIG. 2.

FIG. 5 shows an AI/ML-based in advance detection of a required reliability level.

FIG. 6 shows procedures for the detection of operational conditions of user entities and the selection of a target reliability level in a core network architecture of a 5G-advanced system.

FIG. 7 shows procedures for the detection of operational conditions of user entities and the selection of a target reliability level selection in a core network architecture of a 6G system.

FIG. 8 shows an exemplary method according to this disclosure for a control entity.

FIG. 9 shows an exemplary method according to this disclosure for an application entity.

FIG. 10 shows an exemplary method according to this disclosure for a network entity.

### DETAILED DESCRIPTION OF EMBODIMENTS

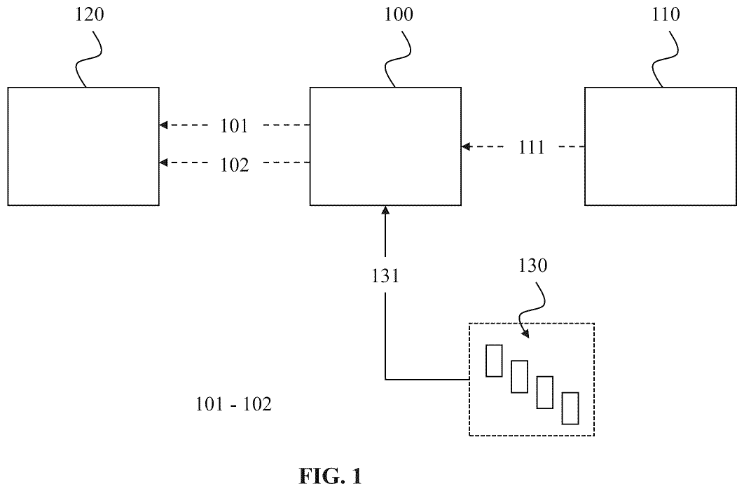

FIG. 1 shows a control entity 100 according to this disclosure, an application entity 110 according to this disclosure, and a network entity 120 according to this disclosure. The control entity 100 may be or may comprise a NWDAF and/or a PCF. The application entity 110 may be or may comprise an application function (AF). The network entity 120 may be or may comprise a network function (NF).

The entities 100, 110, 120 may be suitable for being used in a 5G-advanced, or 6G communication network or system. The entities 100, 110, 120 can be used to dynamically configure a reliability level in a network slice of the communication network or system. One or more user entities 130 may be associated with the network slice, i.e., may use the network slice for communication. The user entities 130 may include robotic devices and humans (i.e., as mentioned above, “human” with user devices, for instance, mobile devices, like smartphones or the like).

The control entity 100 is configured to determine one or more operational conditions 131 of the one or more user entities 130. These operational conditions 131 may comprise at least one of: a distance between a user entity 130 and one or more other user entities 130; a density of multiple user entities 130; a (relative) movement speed of a user entity 130 and/or one or more other user entities 130; a movement direction of a user entity 130 and/or one or more other user entities 130; a movement trajectory of a user entity 130 and/or one or more other user entities 130; and a type of a one or more tasks or operations performed by a user entity 130 and/or one or more user entities 130. The control entity 100 may be configured to measure, estimate, or receive by indication or signaling, the one or more operational conditions 131.

The control entity 100 is further configured to determine a target reliability level 101 or 102 of a communication service in the network slice of the one or more user entities 130, based on the determined one or more operational conditions 131. As an example, the control entity 100 may store dynamic reliability policy information—also referred to as a dynamic reliability policy (DR policy)—related to the one or more user entities 130 using the network slice. This dynamic reliability policy information may comprise a correlation between a plurality of operational conditions 131 for the one or more user entities and a plurality of reliability levels. The control entity 100 may in this case determine the target reliability level 101 or 102 according to the stored dynamic reliability policy information. The control entity 100 may be further configured to provide a first target reliability level 101 and/or a second target reliability level 102 to the network entity 120.

The application entity 110 is configured to provide a reliability related configuration 111 to the control entity 100. The reliability related configuration 111 is configured to instruct the control entity 100 to generate or update the dynamic reliability policy information related to one or more user entities 130. This reliability related configuration 111 can be related to the reference operational condition vs. the required reliability level for the specific application.

The network entity 120 is configured to receive the first target reliability level 101 and/or the second target reliability level 102 from the control entity 100. In particular, the network entity 120 is configured to receive the first target reliability level 101 from the control entity 100 and to enforce it at a first time point (alternatively, to provide the first target reliability level 101 further to another network entity for the enforcement). The network entity 120 is further configured to receive the second target reliability level 102 from the control entity 100 and to enforce it at a second time point (alternatively, to provide the second target reliability level 102 further to another network entity for the enforcement).

The entities 100, 110, 120 may each comprise a processor or processing circuitry (not shown) configured to perform, conduct or initiate the various operations of the respective entity 100, 110, 120 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The entities 100, 110, 120 may further each comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the respective entity 100, 110, 120 to be performed. In one embodiment, the processing circuitry comprises one or more processors and a non-transitory memory connected to the one or more processors. The non-transitory memory may carry executable program code which, when executed by the one or more processors, causes the respective entity 100, 110, 120 to perform, conduct or initiate the operations or methods described herein.

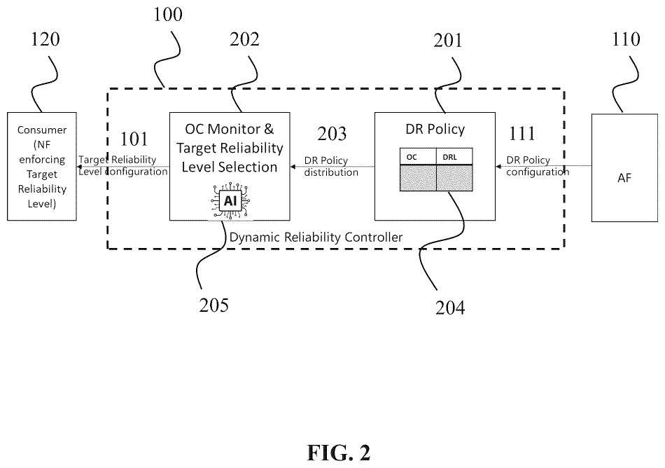

FIG. 2 shows an exemplary architecture of a control entity 100 according to this disclosure, which is in this case implemented as a dynamic reliability controller (DRC). The control entity 100 may comprise a first component 201, which is configured to store a “DR policy” (i.e., the dynamic reliability policy information 204), and a second component 202 for “OC Monitor & Target Reliability Level Selection”. The second module 202 may operate based on an intelligence methodology with a trained model 205, short an artificial intelligence (AI). The AI 205 may, for instance, be used to determine the one or more expected operational conditions 131 of the one or more user entities 130.

The DR policy 204 at the first component 201 may be defined and/or configured by the application entity 110 (here implemented as an AF) and may be based on a correlation of operational conditions (OC) vs. the required dynamic reliability levels (DRL) for a group of cooperating user entities 130. For example, a 3rd party AF 110 can configure the DR policy 204 with respect to OC vs. DRL for a group of cooperating robotic devices and humans in a factory floor in a HRI use case. To this end, the AF 110 may provide the reliability related configuration 111 (also “DR policy configuration”) to the control entity 100. The DR policy 204 can be used to determine (e.g., in advance) a dynamic target reliability level 101 for cooperating user entities 130, for example, robotic devices. The details of the DR policy 204 for the HRI scenario will be defined together with the operational conditions 131 and reliability levels further below.

The AI-based detection mechanism at the second component 202 may estimate the one or more operational conditions 131, and may determine the target reliability level 101 based on the DR policy 204 stored at the first component 201. The first component 201 may distribute the DR policy 204 to the second component 202. The AI mechanism 205 may detect in real-time a dynamic reliability level requirement, so that a proper target reliability level 101 can be selected and, hence, may be enforced in the network slice. The details of the detection of the operational conditions 131 and the selection of the target reliability level are discussed further below.

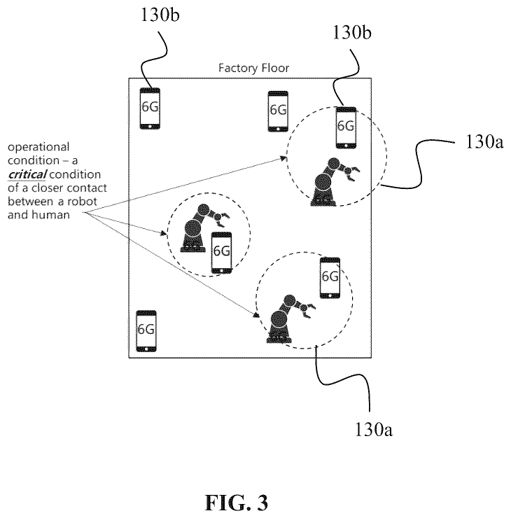

FIG. 3 shows an exemplary scenario, to which the solutions of this disclosure are applicable. In particular, in next-generation vertical applications with HRI or HRC use cases, the presence of humans interacting with moving objects (e.g., robotic devices) may be a crucial control in a 6G System (6GS). In particular, the reliability of HRI or HRC operations may be essential for each network slice and/or for each user entity 130 (i.e., robotic device). The proper reliability requirement at the right time can be essential for many reasons, e.g., for the safety of the work space, the reliability requirement of the robotic device, service level agreement (SLA) assurance, etc. This can be supported by the dynamic reliability feature proposed by this this disclosure. The dynamic reliability feature has two benefits: (i) a higher reliability may be supported by the network slice, only if its application is required, and (ii) an efficient resource and energy consumption can be provided by avoiding a higher static reliability level in the network slice at all times.

Two scenarios of HRI or HRC are considered by this disclosure to support the dynamic reliability.

In a first scenario (scenario 1), robotic devices (i.e., a first type of the user entities 130, thus labelled user entities 130a in FIG. 3) and humans (i.e., a second type of the user entities 130, thus labelled user entities 130b in FIG. 3) do not share tasks, but share a workspace. In this scenario 1 of HRI or HRC, the robotic devices 130a and humans 130b work individually in the same workspace (e.g., a factory floor). By sharing the same workspace, there is a critical condition when the robotic devices 130a and humans 130b have a closer contact to each other. In this condition, i.e., if one or more humans 130b or other robotic devices 130a are closer to a robotic device 130a, in general, the reliability level of the robotic device's 130a running application must be higher than the reliability level used before. The graphical illustration of scenario 1 is presented in FIG. 3.

In a second scenario (scenario 2), the robotic devices 130a and humans 130b share tasks and workspace. In this scenario of HRI or HRC, the robotic devices 130a and humans 130b may work sequentially or collaboratively with each other in the same workspace (e.g., a factory floor). By sharing the same task and workspace, there may be many critical conditions, in particular, when the robotic devices 130a and humans 130b have a closer contact to each other. In this condition, many critical conditions are expected based on the operational conditions 131. An example is the operational condition 131 with a critical collaborative work between a robotic device 130a and human(s) 130b. Another example is a closer contact of task-sharing between a robotic device 130a and human(s) 130b. In each critical condition based on different aspects of the operational conditions 131, in general, the reliability level of the robotic device's 130a running application must be higher than the reliability level used before. This condition may be essential for many reasons, e.g., the safety of work space, the reliability requirements for the application, SLA assurance, etc.

In this disclosure, the above two scenarios 1 and 2 are highlighted, however, the same features of this disclosure can cover other use cases, e.g., service robot use cases where robotic devices 130a and humans 130b have collaborative tasks, hence, static reliability is not needed at all times.

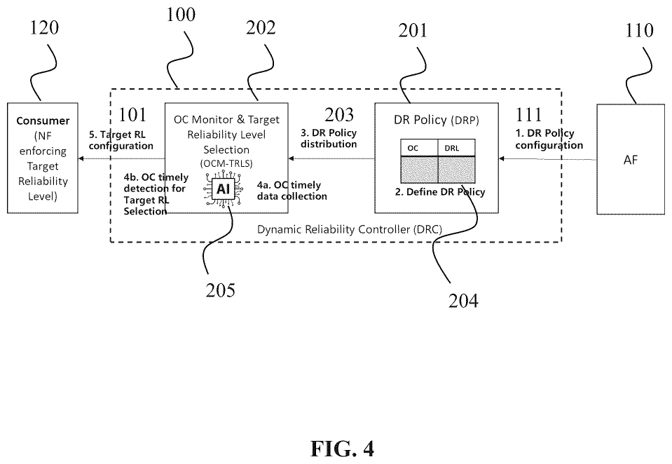

FIG. 4 shows procedures of the dynamic reliability controller (DRC) of FIG. 3. The present disclosure may relate to the core network architecture of a telecommunication system, for example, the core network architecture in a 6G system. For the core network architecture, the present disclosure proposes the DRC (control entity 100) for the network slicing of a core network part. The DRC 100 allows configuring the DR policy 204 for a group of cooperating user devices 130 (e.g., robotic devices 130a and humans 130b) by the AF (application entity 110), and provides the estimated target reliability level to a consumer NF (network entity 120) of the 6G system. Thus, the 6G system can enforce the dynamic reliability requirement for the specific user devices 130 defined by the AF 110. In FIG. 4 the procedures of the DRC 100 are shown by highlighting the corresponding mechanisms, functionalities, and interactions of the DRC components 201 and 202.

1. The DR policy 204 is configured per the AF 110 via an interface to the first component 201. The AF 110 can be a 3rd party AF, for example, a vertical AF which can be outside of the 3GPP system. The first component 201 may receive a 6G DR policy configuration request (i.e. the reliability related configuration 111), which may be related to network slicing. The request 111 includes, but is not limited to, user entities 130 (e.g., robotic device 130a and human 130b) group information, operational conditions 131 (OC) vs. dynamic reliability level (DRL) for the DR policy configuration of the user entities 130, and the identifications of network slice and AF 110. The DR policy configuration 111 with examples operational conditions and dynamic reliability level will be described later.

2. The first component 201 defines the 6G DR policy 204 for the network slice with respect to the operational conditions 131 correlated with a plurality of reliability levels for a specified group of user entities 130. The first component 201 stores the DR policy 204 for the corresponding network slice for the received group of user entities 130 per the AF 110.

3. The defined DR policy 103 is distributed to the second component 202, to determine dynamic target reliability level selection. For example, the DR policy distribution 203 can be considered as policy and charging control (PCC) rule for operational conditions 131 timely detection and target reliability selection.

4a. The second component 202 collects the operational conditions 131 of the factory floor periodically (e.g., every 1 s) or event-based (e.g., based on user entity 130 trajectory). An operational condition is generally defined as a time varying condition (e.g., robotic device and human location(s) at a factory floor) as described above.

4b. Based on the collected operational conditions 131 from step (4a), the second component 202 performs AI-based operational conditions in advance detection. The estimated operational condition is used to determine a target reliability level 101 required based on the DR policy 204 defined in step (2). The capability and requirements of the AI/ML sub-component in the second component 202 are described below.

5. The selected target reliability level 101 is sent to a consumer (e.g., a NF enforcing the target reliability level in the network slice) for the required action execution.

In this disclosure, an operational condition 131 may be defined as a time varying condition, for example, at a factory floor, which may be related to the distance (i.e., geographical distance) between robotic devices 130a and humans 130b and/or the operation of task(s) (i.e., individual task, sequential task, collaborative task, etc.) of robotic devices 130a and/or the movement (i.e., trajectories, directions, speed etc.) of robotic devices 130a and/or the humans 130b. Hence, parameters useful to define operational conditions 131 include, but are not limited to, the distance between a robotic device 103a and a human 130b, the speed of a user device 130, the direction of the user device 130, the task (risk) level of a robotic device 130a, and the density of user devices 130. In the disclosure, a user device 130 (or UE) is defined as a human 130b or a robotic device 130a. In general, there may be two types of operational conditions 131, critical operational conditions and non-critical operational conditions. In the following each type of operational conditions 131 is described with some examples.

A critical operational condition 131 may be defined as a condition at a factory floor related to a user device 130 or group of user devices 130, also referred to as a UE (e.g., a robotic device 130a), which requires a high or extremely high reliability level. In this situation, the dynamic reliability level for the UE (or a group of UEs) is required to increase or maintain the same with respect to the DR policy 204 defined by the AF 110 according to the requirement of the application under the concrete operation condition.

Examples of critical operational conditions 131 include but are not limited to one or more of the following conditions:
When UEs 130 (e.g., a robotic devices 103a and/or humans 130b) share the same workspace and have a closer contact, a higher reliability level is required for the robotic device 130a.
When the UEs 130 (e.g., a robotic devices 130a and/or humans 130b) share the task (sequentially or collaboratively) and the same workspace, a higher reliability level is required for the robotic device 130a.
When UEs 130 (e.g., a robotic devices 130a and/or humans 130b) are moving and/or working (individually and/or collaboratively) in the same workspace, a higher reliability is required for the robotic device 130b.
When the task has changed its reliability requirements to a higher dynamic reliability level.
Other applications with reliability requirements changing in time and/or space from a lower reliability level to a higher reliability level.

A non-critical operational condition 131 is defined as a condition, for example, at a factory floor related to a UE 130 or group of UEs 103, where a UE 130 (e.g., a robotic device 130a) requires a lower reliability level. In this situation, the dynamic reliability level for the UE 130 (or the group of UEs 130) is required to decrease or maintain the same with respect to the DR policy 204 defined by the AF 110 according to the requirement of the application under the concrete operation condition.

Examples of non-critical conditions 131 include but are not limited to the following conditions:
When the task has changed its reliability requirements to a lower dynamic reliability level.
When the direction of UEs 130 (e.g., humans 130b) are getting away from robotic devices 130a, the reliability requirement could be relaxed.

In this disclosure, in general, a minimum of two reliability levels may be considered to support the dynamic reliability feature. The reliability levels may be proposed with respect to the adaptive requirements of networks/sub-networks/services/applications. In the following, a generic definition of dynamic reliability levels is defined for ‘N’ levels (1 . . . . N):
Dynamic reliability Level-1: The reliability requirement is very low, for example, the packet delivery success rate may be lower than 50%.
Dynamic reliability Level-2: The reliability requirement is low, for example, the packet delivery success rate may be at a minimum of 60%.
Dynamic reliability Level-N-1: The reliability requirement is very high, for example, the packet delivery success rate may be very close to 100%, e.g., 10E-6.
Dynamic reliability Level-N: The reliability requirement is extremely high, for example, the packet delivery success rate may be very close to 100%, e.g., 10E-9.

The DR policy 204 is defined as operational conditions 131 vs. (i.e. correlated with) dynamic reliability levels. The DR policy 204 can be defined based on one or more parameters of different operational conditions 131 as presented above. The following examples represent a specific DR policy 204 based on selected operational conditions 131. A similar concept shall be considered for the other parameters of operational conditions 131 described above.

The DR policy 204 from the first example is based on the operational condition 131 related to the distance between a robotic device 130a and affected UEs 130 (i.e., a group of humans 130b and robotic devices 103a, which are closer contact with the robotic device 130b) as presented in Table 1. In this example, the operation condition 131 is defined as a function of geographical distance, dᵢⱼ, where dᵢⱼ is the distance between the robotic UE 130a (R-UEᵢ) and a human UE 130b (H-UEⱼ). Based on different operational conditions 131, in this case, the range of dᵢⱼ, the different dynamic reliability levels will be required. Table 1 represents a DR policy 204 defined by a generic distance dᵢⱼ, vs. a generic DRL, Rij, where Rij is the reliability requirement of R-UEᵢ vs H-UEⱼ. The geographic distance, dᵢⱼ, is defined by a threshold distance Trᵢ where i=1 . . . n where Trᵢ<Trᵢ₊₁. A generic dynamic reliability level, Rij, is defined by an upper bound threshold reliability Rₖ where k=1 . . . . K and R₁>R₂>R₃>R₄ . . . >R_{K}.

In a simple case of two operational conditions 131 and two dynamic reliability levels with Trᵢ=10 m and R1=10E-6 and R2=10E-3, the distance based DR policy 204 is simply defined as DRL-1==10E-6 for dᵢⱼ>10 m and DRL-2==10E-3 for dᵢⱼ<10 m for all UEs (the R-UEᵢ and H-UEⱼ).

TABLE 1
DR policy 204 based on operational conditions 131 related to
the distance between a robot(s) 130a and affected UEs 130

| | OC Functional | | |
|---|---|---|---|
| | Description | Dynamic | |
| Operational | (R-UEᵢ and H-UEⱼ | Reliability | |
| Condition | Distance dᵢⱼ) | Level | Description |
| OC-A = f | 0 ≤ dᵢⱼ < Tr₁ | DRL-1 == | the distance between R-UEi and |
| (dᵢⱼ) | | Rij ≥ R1 | H-UEj for each j (dᵢⱼ) is below a |
| | | | threshold distance Tr₁ |
| OC-B= f | Tr₁ ≤ dᵢⱼ < | DRL-2 == | the distance between R-UEi and |
| (dᵢⱼ) | Tr₂ | Rij≥ R2 | H-UEj for each j (dᵢⱼ) is |
| | | | between a threshold distance |
| | | | Tr₁ and Tr₂ |
| . . . | . . . | . . . | . . . |
| OC-Z = f | Trₙ ≤ dᵢⱼ | DRL-N == | the distance between R-UEi and |
| (dᵢⱼ) | | Rij ≥ RN | H-UEj for each j (dᵢⱼ) is above a |
| | | | threshold distance Trₙ |

The DR policy 204 from the second example is based on the operational condition 131 related to the operation of task of robot(s) 130a. In this example, the task of robots 130a are defined according to the definitions defined by International Federation of Robotics (IFR) [https://ifr.org] as presented in Table 2. In this specific example, four types of operations/task level of robots (responsive collaboration, cooperation, sequential collaboration and coexistence) are defined with respect to the descending order of DRL required (R1>R2>R3>R4). Table 2 represents a DR policy 204 defined by operations of robots vs. a generic DRL, Rij, where Rij is the reliability requirement of R-UEᵢ vs Human UE (H-UEⱼ). Note that a H-UEⱼ can also be considered as another robot UE 130a in this specific example.

TABLE 2
DR policy 204 based on operational condition 131
related to the operation of task of robot(s) 130a

| | Dynamic | |
|---|---|---|
| Operational | Reliability | |
| Condition* | Level | Description |
| OC-A == | DRL-1 == | The robot responds in real-time to movement |
| ‘Responsive | Rij ≥ R1 | of the human worker. The minimum |
| Collaboration’ | | threshold reliability is R1. |
| OC-B == | DRL-2 == | Robot and human work on the same part |
| ‘Cooperation’ | Rij ≥ R2 | at the same time, with both in motion. |
| | | The minimum threshold reliability is R2. |
| OC-C == | DRL-3 == | Human and robot are active in shared |
| ‘Sequential | Rij ≥ R3 | workspace but their motions are |
| Collaboration’ | | sequential; they do not work on a part |
| | | at the same time. The minimum threshold |
| | | reliability is R3. |
| OC-D == | DRL-4 == | Human and robot work alongside each other |
| ‘Coexistence’ | Rij ≥ R4 | without a fence, but with no shared |
| | | workspace. The minimum threshold |
| | | reliability is R4. |
| . . . | . . . | . . . |

Based on the DR policy 204, for each robotic device 130a in a HRI scenario, the change of the target reliability level 101 (i.e., increase or decrease by one or more reliability levels) can be determined according to the (estimated) operational conditions. How the 6GS can detect in advanced the required reliability level is described in the following sections.

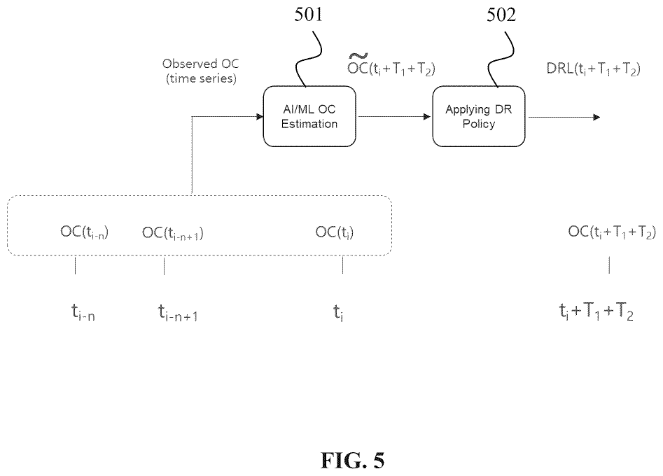

FIG. 5 illustrates the AI/ML based estimation of operational conditions 131 for in advance reliability level detection. In simple terms, the AI/ML in the second component 202 may be used to allow the in advance detection of the reliability level required. “In advance” means the time to enforce the requirement must be considered, i.e., the needed time to perform the path selection (T1) and to perform the path selection enforcement (T2).

Based on the operational conditions 131 monitored until a time instant t, the AI/ML 205 in the second component 202 shall determine a sufficiently accurate estimation of operational conditions (t+T1+T2) and hence the corresponding reliability level required at instant t+T1+T2.

As illustrated in FIG. 5, generally, in instant tᵢ, the AI/ML 205 in the second component 202 may detect the reliability level required at tᵢ+T (e.g. T=T1+T2). The reliability level required is determined by the DR policy 204 upon operational conditions 131. Hence, AI/ML 205 may estimate operational conditions 131 at tᵢ+T upon observation of operational condition 131 until tᵢ. The AI/ML 205 in the second component 202 may aim at estimating with sufficient accuracy the operational conditions 131 at tᵢ+T upon observation of operational conditions 131 until tᵢ.

As described above, the basic requirement of the AI/ML 205 may support the following:
Sufficient accuracy with limited input time series
Fast model learning
Robustness of model with respect to varying environmental conditions.

To achieve the requirements, AI/ML technologies such as Deep Learning (DL) or MTAA-GAT can be considered as machine learning (ML) for irregular time series and Least Absolute Shrinkage and Selection Operator (LASSO) or Long Short-Term Memory (LSTM) can be used for regression techniques.

The operational conditions 131 monitoring can be performed by the second component 202. One or more operational conditions data in time series, described above, can be collected and detected for a group of UEs 130 by the network. The feature allows the second component 202, for example in 5G-advanced or 6G systems, to be configured to detect specific monitoring events and reports the events to any consumer NFs of the network. The operational condition monitoring events are listed in Table 3.

TABLE 3
List of OC monitoring events

| | | Which NF detects |
|---|---|---|
| Event | Detection criteria | the event |
| UE location | This event detects and | OCM-TRLS |
| | reports either the Current | |
| | Location or the Last Known | |
| | Location of a UE. | |
| Distance between | This event detects either the | OCM-TRLS |
| a UE and other | Current Location or the | |
| group of UEs | Last Known Location of a | |
| | UE and the group of UEs. | |
| | Then the distance (i.e., | |
| | geographical distance) from | |
| | the UE to the other group of | |
| | UEs are computed and | |
| | reported, e.g., in ascending | |
| | order. (see NOTE 1, NOTE 4) | |
| Operation of | This event detects and | OCM-TRLS |
| task(s) of UE | reports either the Current | |
| | operation of task or the Last | |
| | Known operation of task of | |
| | a UE. (see NOTE 2, NOTE 4) | |
| Movement of UE | This event detects and | OCM-TRLS |
| | reports the movement of a | |
| | UE in time series. The | |
| | movement of a UE includes | |
| | Last Known Locations of | |
| | the UE, the directions of the | |
| | UE and the speed of the | |
| | UE. (see NOTE 3, NOTE 4) | |
| NOTE 1: | The UE is a robotic device | |
| | and the group of UEs | |
| | includes a mixed of robotic | |
| | UEs and human UEs. | |
| NOTE 2: | The operation of task of a | |
| | UE includes but are not | |
| | limited to individual | |
| | operation, sequential | |
| | operation with a group of | |
| | UEs, collaborative | |
| | operation with a group of | |
| | UEs. (see NOTE 1 for the | |
| | UE definition) | |
| NOTE 3: | The movement of a UE | |
| | includes but are not limited | |
| | to the trajectories, | |
| | directions, and speed of the | |
| | UE. | |
| NOTE 4 | It is assume that the | |
| | network is able to detect the | |
| | location, operation of task | |
| | or movement of a Robot | |
| | UE or Human. | |

The following services may be defined for the operational conditions monitoring events at the workspace, e.g., a factory floor by the network. Basically, the services are provided by the data source NFs, for example UE itself or AMF or other CP NFs. Alternatively a 3^{rd} party NF (e.g., NEF in 5G-advanced system) can also be provided.

The second component 202 utilizes the services provided by the data source NFs or a 3^{rd} party NF in order to detect the events. The service operations related to the operational conditions monitoring events are described in the followings tables:

TABLE 4
Service operations related to the operational conditions 131
with respect to distance between a UE 130 and other UEs 130

Service operation name: OcmTrls_OCAsDistance Subscribe
Description: the consumer subscribes to receive an event related to
the distance of a UE.
Inputs, Required: UE ID, Group of UE IDs,
Inputs, Optional: location of UEs, Event filtering information, e.g.,
when the location of the UE has changed.
Outputs, Required: When the subscription is accepted: Subscription
Correlation ID, Expiry time (required if the subscription can be expired
based on the operator's policy).
Outputs, Optional: None
Service operation name: : OcmTrls_OCAsDistance_Notify
Description: OCM-TRLS reports the event to the consumer that has
previously subscribed.
Inputs, Required: Event ID, Notification Correlation Information,
time stamp.
Inputs, Optional: Event information (defined on a per Event ID basis),
Event Removal Indication, list of group member UE(s) whose subscription
to event notification(s) are removed from a group-based event notification
subscription.
Outputs, Required: Operation execution result indication. The result
includes the distance between the UE and the group of UEs based on the
subscription.
Outputs, Optional: If the group of UE IDs are provided in the subscription,
the correlation of operation of task should be provided. For example, UE
#1 and UE#2 are operating sequentially.

TABLE 5
Service operations related to the operation
of task of a UE 130 or a group of UEs 130

Service operation name: OcmTrls_OperationsOfTask_Subscribe
Description: the consumer subscribes to receive an event related to the
operations of task of a UE, or if the event is already defined in NEF,
then the subscription is updated.
Inputs, Required: UE ID, location of UE, S-NSSAI
Inputs, Optional: Group of UE IDs, application ID, service area
information, event filter information including reporting information,
e.g., periodically or event based.
Outputs, Required: When the subscription is accepted: Subscription
Correlation ID, Expiry time (required if the subscription can be expired
based on the operator's policy).
Outputs, Optional: None
Service operation name: OcmTrls_OperationsOfTask_UnSubscribe
Description: the NF consumer deletes an event.
Inputs, Required: Subscription Correlation ID.
Outputs, Required: Operation execution result indication.
Service operation name: OcmTrls_OperationsOfTask_Notify
Description: OCM-TRLS reports the event to the consumer that has
previously subscribed.
Inputs, Required: Event ID, Notification Correlation Information,
time stamp.
Inputs, Optional: Event information (defined on a per Event ID basis),
Event Removal Indication, list of group member UE(s) whose subscription
to event notification(s) are removed from a group-based event
notification subscription.
Outputs, Required: Operation execution result indication.
Outputs, Optional: If the group of UE IDs are provided in the subscription,
the correlation of operation of task should be provided. For example, UE
#1 and UE#2 are operating sequentially.

When the operational conditions 131 monitoring event is detected, the target reliability level selection can be performed by the second component 202. The detailed method of a target reliability level selection is described above.

The feature allows the second component 202 in 5G-advanced or 6G system the ability to detect the specific reliability requirement and provide to any consumer NFs of the network, hence, the required action can be taken to achieve it. By utilizing one or more of the monitoring events described in Table 3, the second component 202 of the control entity 100 computes and estimates the target reliability required for a UE 130 or a group of UEs 130 as per the methods described above.

The target reliability level selection services provided by the second component 202 are listed in Table 6.

TABLE 6
Target reliability level selection services

Service operation name: OcmTrls_SingleUETargetReliabilityLevel_Subscribe
Description: the consumer subscribes to receive an event related to the change of target
reliability level of a single UE, or if the event is already defined in NEF of 5G-A, then the
subscription is updated.
Inputs, Required: UE ID, S-NSSAI, Group of UE IDs, locations of UEs in time series.
Inputs, Optional: Application ID, service area information, event filter information including
event based reporting information.
Outputs, Required: When the subscription is accepted: Subscription Correlation ID, Expiry
time (required if the subscription can be expired based on the operator's policy).
Outputs, Optional: None
Service operation name: OcmTrls_GroupUETargetReliabilityLevel_Subscribe
Description: the consumer subscribes to receive an event related to the change of target
reliability level of a group of UEs, or if the event is already defined in NEF of 5G-A, then the
subscription is updated.
Inputs, Required: UE IDs, S-NSSAI(s)
Inputs, Optional: locations of UEs, application ID, service area information, event filter
information including event based reporting information.
Outputs, Required: When the subscription is accepted: Subscription Correlation ID, Expiry
time (required if the subscription can be expired based on the operator's policy).
Outputs, Optional: None
Service operation name: OcmTrls_UETargetReliabilityLevel_Notify
Description: OCM-TRLS reports the event to the consumer that has previously subscribed.
The report includes the required target reliability level.
Inputs, Required: Event ID, Notification Correlation Information, time stamp.
The notification correlation information includes one or more required target reliability level
of the UE or group of UEs depending on the subscribed event.
Inputs, Optional: Event information (defined on a per Event ID basis), Event Removal
Indication, list of group member UE(s) whose subscription to event notification(s) are removed
from a group-based event notification subscription.
Outputs, Required: Operation execution result indication.
Outputs, Optional: If the group of UE IDs are provided in the subscription, the correlation of
operation of task should be provided. For example, UE #1 and UE#2 are operating sequentially.

The present disclosure may be intended as a core Network feature for a 6G System. In particular, this disclosure and its solutions may be a part of a policy control entity in 6GS (e.g., the first component 201 of FIG. 2) and a part of intelligent component in 6GS (e.g., the second component 202 of FIG. 2).

Embodiments of the present disclosure may be categorized for two systems (i) 5G-advanced system in embodiment 1 and (ii) 6G system in embodiment 2. In addition, the dynamic reliability in the network slice in a form of an attribute, a parameter, and a network slice type) is proposed as an embodiment 3.

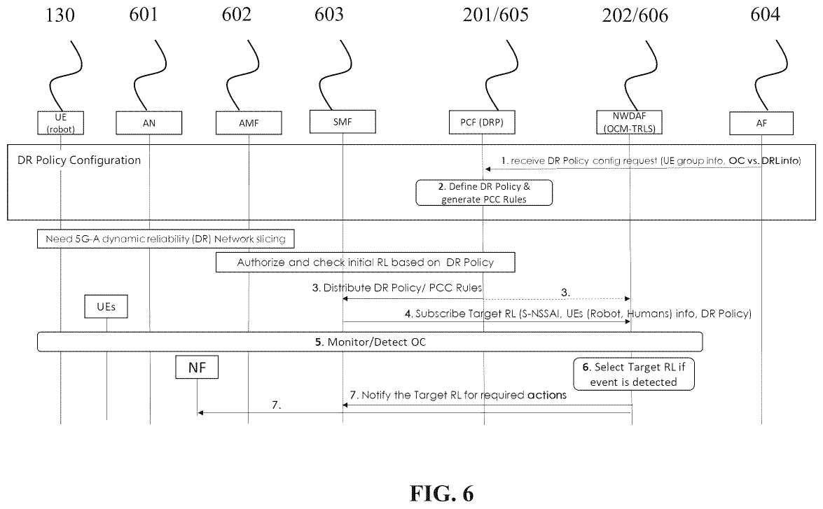

The scope of embodiment 1 is intended for 5G-advanced systems. The embodiment 1 is related to the method of how a system in advance can detect and select the required reliability level for dynamic reliability supported 5G-advanced network slicing. The NFs performing the features of this disclosure, the methods, the details procedures and interactions between these NFs and the required information interactions are presented in FIG. 6.

Method and procedures for operational conditions detection and a target reliability selection based on PCF and SMF in 5G-Advanced system is presented in FIG. 6. The procedures defined in FIG. 6 includes two folds: (i) DR policy configuration (steps 1-2) and (ii) operational condition detection and selection (steps 3-5). It is assumed that the DR policy configuration is done before and during the service or application is in operation. The initial DR policy configuration is done before the service or application is in operation while the modification of DR policy configuration is done during the service or application is in operation. However, the operational conditions detection and selection process can only be done during the service or application is in operation.

1. A 3^{rd} party AF 110 (e.g., a vertical AF) configures the DR policy 204 for a group of UEs 130 (i.e., robotic devices 130a and humans 130b) with the 5G-advanced system. The core network function PCF 605 (corresponding to the first component 201) is responsible for the policy configuration, hence, the PCF 605 receives the DR policy configuration request 111 sent by the AF 110. The request includes but are not limited to one or more of the parameters (i.e., the identifications of a group of robotic UEs 130a and human UEs 130b, the UEs 130 addressing information (e.g., allocated IPv4/IPv6 address, interface identifier), operational conditions 131 vs. reliability levels, AF identifications, network slice information). It may be assumed that human UEs 130b are attached with communication devices and the identifications of human UEs 130b refers to the identifications of such communication devices. It is also assumed that the robotic UEs 130a are connected to the network, hence, the operational conditions 131 of robotic UEs 130, e.g., the distance between a robotic UE 130a and other UEs 130 can be provided and collected from 5G-advanced network entities. The DR policy 204 is application specific and dependent on different aspects of operational conditions 131 and its required dynamic reliability level.

2. The PCF 605 defines DR policy 204 per group of UEs 130 per use case per AF 110 for the network slice based on the received information from AF 110. Network slice information can be provided by either AF 110 or 5G-advanced system itself. The PCF 605 with stores the DR policy 204 for the corresponding network slice per group of UEs 130 per use case per AF 110. The PCF 605 may provide the DR policy 204 in Policy and charging control (PCC) rule for the UE(s) 130.

Notably, in order to detect in advance operational conditions 131 and select the target reliability level, it is assume that a robotic UE 130a is in operation and connected to the network with 5G-advanced dynamic reliability network slicing. During the initial registration and PDU Sessions establishment procedures, the network determines and selects the dynamic reliability supported network slice, for example, based on the required reliability level from DR policy 204 or maximum available reliability level. During this process, the DR policy 204 is provided by the PCF 605 (i.e., step 3). After the PDU session(s) has been established, the network performs operational condition monitoring. The list of operational condition data to be monitored in the workspace, e.g., a factory floor, is dependent on the specific operational conditions 131 defined in DR policy 204, which is dependent on application.

3. The PCF 605 distributes the DR policy 204 for UE(s) 130, for example in a form of PCC rules, to the SMF 603 (and optionally NWDAF 606, corresponding to the second component 202). The DR policy 205 in the SMF 603 is used to establish the initial PDU session, e.g., when a robotic UE 130a communicates to the network for the dynamic reliability network slicing. The DR policy 204 in the NWDAF 606 is used to perform operational conditions 131 monitoring, to determine in advance operational conditions detection and to select the dynamic target reliability level.

4. The SMF 603 subscribes the event based target reliability level 101 from the NWDAF 606. The subscription includes the network slice identification(s) (i.e., S-NSSAI), UEs information (i.e., UE identifications, UE addressing information), and optionally DR Policy related to the UEs. If DR policy 204 for the UEs 130 is not included in the subscription, the NWDAF 606 can get it from the PCF 605 in step 3.

5. In order to determine in advance operational conditions detection, the NWDAF 606 may need to collect the required operational conditions, which is time varying conditions of the workspace, e.g., a factory floor, periodically (e.g., every 1 s) or event-based (e.g., based on the change of UE location). Based on the KPIs defined in the DR policy 204, NWDAF 606 initiates operational conditions monitoring events. The services related to the operational conditions monitoring detects the event. The services related to the OC monitoring are defined above.

6. Based on the collected operational conditions data, the NWDAF 606 performs AI-based operational conditions in advance detection. When the change of operational conditions 131 is detected, the NWDAF 606 determines the target reliability required for the detected operational conditions 131 based on the DR policy 204 received from the PCF 605 in step 3. The services related to the operational conditions 131 detection are defined above.

7. When the event occurs, after the selection of a target reliability level 101, the NWDAF 606 notifies to the SMF 603 for the subscribed event, hence, the SMF 603 executes the required action for the selected target reliability level 101. If necessary, the NWDAF 606 notifies or sends the target reliability level 101 to a consumer NF (e.g., a dedicated NF enforcing the target reliability level 101) per subscription or request.

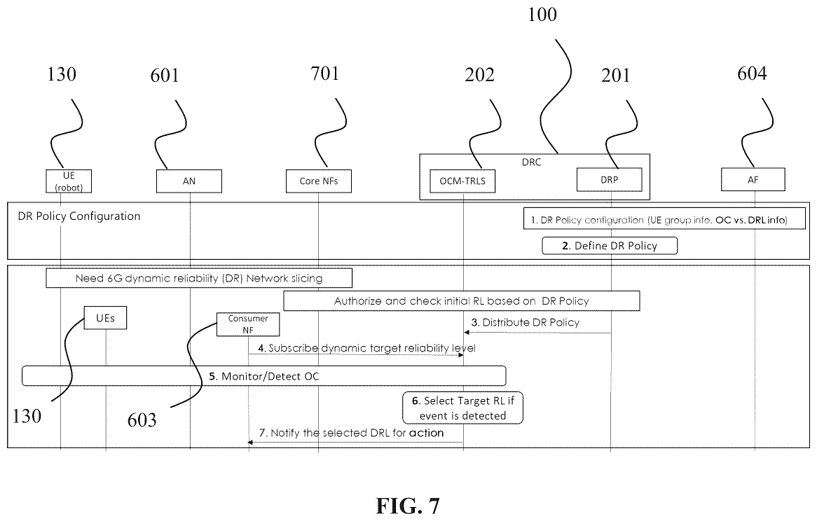

The scope of embodiment 2 is intended for 6G systems. The methods, the details procedures and interactions between proposed network entities in this disclosure and the required information interactions are presented in FIG. 7.

Basically, the method and procedures for in advance detection and selection of the required reliability level described in the embodiment 1 is the same for the scope of the 6G system with the following differences:
The network entity of DRC 100 can be a single entity or two different entities for handling in advanced operational conditions 131 monitoring and target reliability level selection. In the case of a single entity, the step 3 above can be skipped. In the case of two different entities (i.e., first and second components 201 and 202) as presented in FIG. 7, the procedures are identical with the embodiment 1, where the first component 201 can be replaced with the PCF 605, the second component 202 can be replaced with the NWDAF 606, and the consumer NF can be replaced with the SMF 603.

Embodiment 3 addresses how a system (i.e., 5G-advanced or 6G) is aware of dynamic reliability feature or support required in network slice. Three options are proposed.

A first option (option 1) introduces a new attribute “dynamic reliability” for the network slicing as presented in Table 3. By introducing it, a type of network slice (e.g., URLLC slice type) is able to characteristic with dynamic reliability, hence, the 5G-advanced or 6G System is able to support management and control of dynamic reliability feature accordingly.

The concept of attribute is the same as Generic Slice Type (GST) attributes. The new attribute “dynamic reliability” can be considered as performance related character attribute and it can be optional or conditional. Table 3 represents the dynamic reliability attribute. The example of allowed value for the dynamic reliability is as follows:
DR value “0”: no dynamic reliability is supported
DR value “1”: low—dynamic reliability is supported with the best effort response time
DR value “2”: medium—dynamic reliability is supported with a good response time
DR value “3”. high—dynamic reliability is fully supported with a fast response time

The definition of response time is dependent on the Application's requirement. For example, a good response time is in seconds or a fast response time is in milliseconds.

TABLE 7
A new attribute “dynamic reliability” for the network slicing

| Slice attribute name | Dynamic Reliability |
|---|---|
| Measurement unit | NA |
| Allowed value | Any desired value |
| Tags | Character attribute/Performance KPI |
| Present | Optional/Conditional |

In a second option (option 2), the AF 101 interacts with the 5G-advanced or 6G system for the dynamic reliability requirement. The information about dynamic reliability requirements for the application includes one or more of the followings:
Information about dynamic reliability requirement per UE 130 (or group of UEs 130): The same example from option 1 can be considered as the dynamic reliability requirement. Alternatively, the dynamic reliability requirement can be provided as a percentage value (e.g., as described above) or a range of percentage value.
Information about UE 130 or group of UEs 130: It includes identification of UE(s) and UE addressing information, and indication of the correlation between UEs or the reliability requirements of UEs. The correlation between UEs or reliability requirements of UEs can be a factor of operations of task, the movement, the distance, etc.

TABLE 8
New application parameter for dynamic reliability feature

| Information | Applicable for PCF or | Applicable for NEF | |
|---|---|---|---|
| Name | NEF (NOTE 1) | only | Category |
| Traffic | Defines the target traffic to be | The target traffic can be | Mandatory |
| Description | influenced, represented by the | represented by AF- | |
| | combination of DNN and S-NSSAI, | Service-Identifier, | |
| | and application identifier or traffic | instead of combination | |
| | filtering information. | of DNN and optionally | |
| | | S-NSSAI. | |
| Potential | Indicates potential locations of | The potential locations | Conditional |
| Locations of | applications, represented by a list | of applications can be | (NOTE 2) |
| Applications | of DNAI(s), | represented by AF- | |
| | | Service- Identifier | |
| Dynamic | Indicates the dynamic reliability | N/A | Optional |
| reliability | requirements (with DRL values) | | |
| requirement | | | |
| . . . | | | |

In a third option (option 3), the enhancements of new slice types are introduced with dedicated SST values. Basically, the existing network slice types, URLLC, MIoT, V2X and HMTC are considered for the enhancement due to their requirements on dynamic reliability from a lower DRL to a higher DRL or vice versa. The SST values provided in the Table 5 are example values and can be any integer number that are not standardized by the other slice types.

Based on the new slice types, the network is aware of the dynamic reliability feature and can support the necessary control mechanisms as presented in Section 4 accordingly. In particular, the following new slice types are introduced.
Dyn-URLLC—Dynamic URLLC slice, which is the enhancement of URLLC defined in [x] with the dynamicity feature of at least reliability requirement.
Dyn-MIoT—Dynamic MIOT slice, which is the enhancement of MIOT defined in [x] with the dynamicity feature of at least reliability requirement.
Dyn-V2X—Dynamic V2X slice, which is the enhancement of V2X defined in [x] with the dynamicity feature of at least reliability requirement.
Dyn-HMTC-Dynamic HMTC slice, which is the enhancement of HMTC defined in [x] with the dynamicity feature of at least reliability requirement.

TABLE 9
New Slice types with the enhancement
of dynamic reliability feature.

| | SST | |
|---|---|---|
| Slice/service | value | |
| type | (example) | Characteristic |
| Dyn_URRLC | 10 | Slice suitable for the handling of |
| | | enhanced of ultra-reliability low |
| | | latency communications with the |
| | | feature of dynamic reliability. |
| Dyn_MIoT | 11 | Slice suitable for the handling of |
| | | enhanced massive IoT with the feature |
| | | of dynamic reliability. |
| Dyn_V2X | 12 | Slice suitable for the handling of |
| | | enhanced V2X with the feature of |
| | | dynamic reliability |
| Dyn_HMTC | 13 | Slice suitable for the handling of |
| | | enhanced High-Performance Machine- |
| | | Type Communications with the feature |
| | | of dynamic reliability |

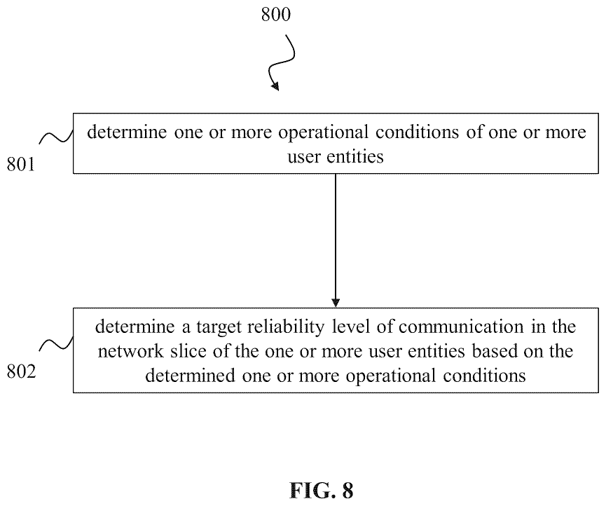

FIG. 8 shows a method 800 according to an embodiment of this disclosure. The method 800 is used for configuring a reliability level of a communication service in a network slice of a communication network. The method 800 is performed at a control entity 100, e.g., the DRC of FIG. 2. The method 800 comprises a step 801 of determining one or more operational conditions 131 of one or more user entities 130, and a step 802 of determining a target reliability level 101 of the communication service in the network slice of the one or more user entities 130 based on the determined one or more operational conditions 131.

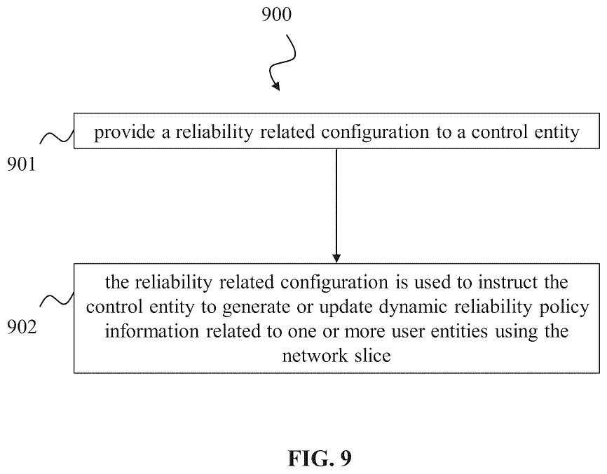

FIG. 9 shows a method 900 according to an embodiment of this disclosure. The method 900 is used for configuring a reliability level of a communication service in a network slice of a communication network. The method 900 is performed at an application entity 110, e.g., an AF. The method 900 comprises a step 901 of providing a reliability related configuration 111 to a control entity 100, wherein the reliability related configuration 111 may be used 902 to instruct the control entity 100 to generate or update dynamic reliability policy information related to one or more user entities 130 using the network slice. The dynamic reliability policy information comprises a correlation between a plurality of operational conditions 131 for of the one or more user entities 130 using the network slice and a plurality of reliability levels.

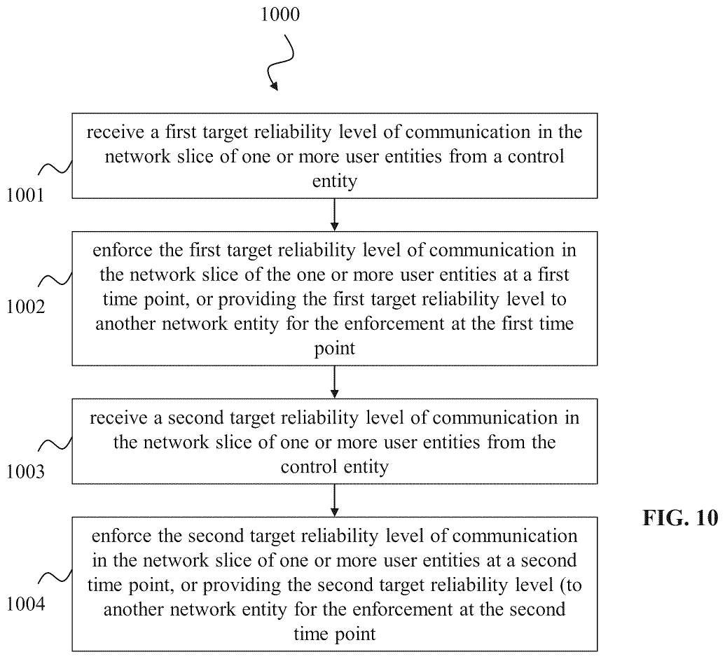

FIG. 10 shows a method 1000 according to an embodiment of this disclosure. The method 1000 is used for configuring a reliability level of a communication service in a network slice of a communication network. The method 1000 is performed at a network entity 120, e.g., a NF. The method 1000 comprises a step 1001 of receiving a first target reliability level 101 of the communication service in the network slice of one or more user entities 130, from a control entity 100. The method 1000 further comprises a step 1002 of enforcing the first target reliability level 101 of the communication service in the network slice of the one or more user entities at a first time point, or providing the first target reliability (101) level to another network entity (e.g., the network entity 120 described with respect to FIG. 1) for the enforcement at the first time point. The method 1000 further comprises a step 1003 of receiving a second target reliability level 102 of the communication service in the network slice of one or more user entities 130 from the control entity 100, and a step 1004 of enforcing the second target reliability level 102 of the communication service in the network slice of one or more user entities 130 at a second time point, or providing the second target reliability level 102 to another network entity for the enforcement at the second time point.

In summary a control entity 100 (DRC) in a communication network or subnetwork supporting feature of dynamic reliability with at least two different dynamic reliability levels is provided for dynamic reliability supported 6G Network Slices. The advantageous effects of this feature is that 6G System ability to determine and select the proper reliability level to be provisioned dynamically without leveraging on resource overprovisioning at all times.

Further, interfaces, procedures, information exchange, and rules related to dynamic reliability policy configuration by a third party AF 110 (e.g., Vertical owned) in 6G system (i.e., the second component 202 of the DRC 100) are provided. The advantageous effect of this feature is that the 6G system allows a 3^{rd} party AF 110 to configure DR policy configuration for its application so that 6G system can support the required or corresponding target DR level based on the DR policy.

Further, DR policy 204 definition based on operational conditions 131 vs. dynamic reliability levels is provided. The advantageous effect of this feature is that the policy for dynamic reliability control is identified as required for a group of cooperating UEs 130.

Further, procedures and method for AI-based in advance detection of (dynamic) target reliability level are provided. The advantageous effect of this feature is the 6G system ability to detect the “dynamic” reliability level requirement.

The field of this disclosure is related to the dynamic reliability for 5G-advanced or 6G network slicing in core network architecture. In the present disclosure, the relevant scope of the technical solutions s HRI/HRC scenarios. However, the technical solutions proposed in this disclosure is also relevant to the other technical fields of service robots use cases which require the interaction or collaboration between humans and robotic devices. In this case, the operational conditions 131 defined in the disclosure may not be fully covered the operational conditions 131 needed for the service robots. However, the methods and procedures for the in advanced detection of operational conditions 131 can be applied to the other operational conditions 131 parameters. Based on this the same technical solutions of the target reliability detection can be applied.

In addition, the dynamic reliability policy configured by AF proposed in this invention can be configured by the 5G-advanced or 6G management system based on the SLA between an operator and a 3^{rd} party service provider. In this case, the 5G-advanced or 6G system does not allow a 3^{rd} party AF to configure the policy required for the group of UEs. Although it is not a flexible option for the 3^{rd} party AFs, e.g., in the case of updates on the application's reliability requirement or the group of UEs, the same inventive objective can be achieved.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A control entity for configuring a reliability level of a communication service in a network slice of a communication network, the control entity comprising:
a processor; and
a memory coupled to the processor and having processor-executable instructions stored thereon, wherein the processor executes the instructions and cause the control entity to:
determine one or more operational conditions of one or more user entities; and
determine a target reliability level of the communication service in the network slice of the one or more user entities based on the determined one or more operational conditions.

2. The control entity according to claim 1, wherein the processor further executes the instructions and cause the control entity to:
enforce the target reliability level of the communication service in the network slice of the one or more user entities; or
provide the target reliability level to a network entity for the enforcement of the target reliability level of the communication service in the network slice of the one or more user entities.

3. The control entity according to claim 1, wherein the processor further executes the instructions and cause the control entity to:
store dynamic reliability policy information related to the one or more user entities using the network slice, wherein the dynamic reliability policy information comprises a correlation between a plurality of operational conditions for the one or more user entities and a plurality of reliability levels; and
determine the target reliability level of the communication service in the network slice of the one or more user entities based on the determined one or more operational conditions and according to the dynamic reliability policy information.

4. The control entity according to claim 1, wherein the processor further executes the instructions and cause the control entity to:
select the target reliability level from a plurality of reliability levels having different percentage value of packet delivery success rate to a given system entity.

5. The control entity according to claim 3, wherein the processor further executes the instructions and cause the control entity to:
expose the stored dynamic reliability policy information related to the one or more user entities, so that the stored dynamic reliability policy information is configurable by an application entity; and/or
generate and/or update the dynamic reliability policy information based on a reliability configuration received from the application entity or from a network entity.

6. The control entity according to claim 1, wherein the processor further executes the instructions and cause the control entity to:
determine the one or more operational conditions of the one or more user entities by estimating, at a first time point, the one or more operational conditions related to the one or more user entities for a second time point, wherein the second time point is later than the first time point; and
determine the target reliability level for the first time point and second time point based on the one or more estimated operational conditions of the one or more user entities.

7. The control entity according to claim 1, wherein the processor further executes the instructions and cause the control entity to:
determine the one or more operational conditions by estimating the one or more operational conditions based on previously determined one or more operational conditions of the one or more user entities.

8. The control entity according to claim 1, wherein the processor further executes the instructions and cause the control entity configured to:
determine the one or more operational conditions of the one or more user entities using an intelligence methodology with a trained model.

9. The control entity according to claim 1, wherein the processor further executes the instructions and cause the control entity to:
continuously monitor or determine the one or more operational conditions of the one or more user entities.

10. The control entity according to claim 1, wherein the one or more operational conditions of the one or more user entities comprise at least one of:
a distance between a user entity and two or more other user entities;
a density of multiple user entities;
a movement speed of a user entity and one or more other user entities;
a movement direction of a user entity and one or more other user entities;
a movement trajectory of a user entity and one or more other user entities;
a type of a task or operations performed by a user entity and one or more user entities.

11. The control entity according to claim 1, wherein:
the user entities comprise a first group of one or more user entities and a second group of one or more user entities; and
the one or more operational conditions of the user entities comprise one or more distances between a respective user entity of the first group and a respective user entity of the first group or the second group.

12. The control entity according to claim 11, wherein the processor further executes the instructions and cause the control entity to:
determine a higher target reliability level, based on a minimum distance of the one or more distances being below a threshold value; and
determine a lower target reliability level, based on the minimum distance of the one or more distances being equal to or above the threshold value.

13. The control entity according to claim 1, wherein
the user entities comprise a first group of one or more user entities and a second group of one or more user entities; and
the one or more operational conditions comprise a number of collaborative tasks performed by at least one user entity of the first group and at least one user entity of the second group.

14. The control entity according to claim 1, comprising a network data analytics function (NWDAF) or a network intelligent function,
wherein the NWDAF or the network intelligent function is configured to determine the one or more operational conditions of the one or more user entities and to determine the target reliability level of the one or more user entities.

15. The control entity according to claim 3, further comprising a policy control function (PCF), which is configured to maintain and/or generate and/or update the dynamic reliability policy information.

16. An application entity for configuring a dynamic reliability policy information of a communication service in a network slice of a communication network, the application entity comprising:
a processor; and
a memory coupled to the processor and having processor-executable instructions stored thereon, wherein the processor executes the instructions and cause the application entity to:
provide a reliability related configuration to a control entity;
wherein the reliability related configuration is adapted to instruct the control entity to generate or update dynamic reliability policy information related to one or more user entities using the network slice; and
wherein the dynamic reliability policy information comprises a correlation between a plurality of operational conditions for the one or more user entities (130) using the network slice and a plurality of reliability levels.

17. A network entity for configuring a reliability level of a communication service in a network slice of a communication network, the network entity comprising:
a processor; and
a memory coupled to the processor and having processor-executable instructions stored thereon, wherein the processor executes the instructions and cause the network entity to:
receive a first target reliability level of the communication service in the network slice of one or more user entities, from a control entity;
enforce the first target reliability level of the communication service in the network slice of the one or more user entities at a first time point, or provide the first target reliability level to another network entity for the enforcement at the first time point;
receive a second target reliability level of the communication service in the network slice of one or more user entities, from the control entity; and
enforce the second target reliability level of the communication service in the network slice of one or more user entities at a second time point, or provide the second target reliability level to another network entity for the enforcement at the second time point.
